(19) United States
(12) Patent Application Publication
(10) Pub. No.: US 2016/0350501 A1
(43) Pub. Date: Dec. 1, 2016

(54) METHOD AND A SYSTEM FOR ESTIMATION OF MEDICAL BILLING CODES AND PATIENT FINANCIAL RESPONSIBILITY

(71) Applicant: EnableDoc LLC, McLean, VA (US)

(72) Inventors: Stephen Rothschild, Rochester, MN (US); Nagendra Goel, McLean, VA (US); Prabhakar Ranjan, Noida (IN)

(21) Appl. No.: 14/725,929

(22) Filed: May 29, 2015

(51) Int. Cl. G06F 19/00; G06Q 30/04

(52) U.S. Cl. CPC G06F 19/328; G06Q 30/04

(57) ABSTRACT

A system and method for estimating medical billing codes and patient's financial responsibility for the services availed or to be availed by patients from medical services providers and legal healthcare organizations is provided. The system provides a platform to users such as patients, medical services providers, and legal healthcare organizations to be informed in advance about estimated prices of medical services and medical insurance coverage to be availed by the patients. Patient's financial responsibility is calculated from medical concepts stored in the system and corresponding historical billing codes and medical insurance coverage for a patient. Further, methods of setting custom rules in the system to refine results based on patient demographics and other parameters are provided. Advantageously, the system provides automatic sharing of information among users and notifications on updated information and helps the users to enquire, network and market their services.

### FIELD OF THE INVENTION

The present invention generally relates to a method and a system for estimation of medical billing codes and patient's financial responsibility, and more particularly to a method and a system for estimation of medical billing codes and patient's financial responsibility according to the most frequently used medical services and billing codes.

### BACKGROUND

With increasing costs of high deductible insurance plans and greater patient financial out-of-pocket responsibility, patients need to have an estimate of medical expenses and the amount they owe prior to medical services, procedures, and tests. Patients desire to compare medical expenditures from different medical service providers before starting treatments to make an informed decision concerning which organization to select. Furthermore, surgical procedures being performed by medical service providers in different legal healthcare organizations require coordination of insurance and clinical information to generate estimates for each organization.

Estimating the cost of medical services, procedures, and tests requires proper selection of billing codes. Billing codes and billing modifiers define the type of services, procedures, and tests performed. Clinical procedures, and their corresponding billing codes are selected based on the diagnosis or group of diagnosis, location of the problem, location of the services, and type of medical service. Treatments and procedures (and therefore billing codes) can vary from provider to provider for the same group of or individual diagnosis due to their individual preferences. Prior solutions estimate costs based on cost averages across geographical areas for selected services or service categories or service bundles. These solutions do not adapt the estimated services, treatments, procedures, or tests based on each provider's historical pattern of billing code selection by diagnosis or group of diagnosis.

With the advent of electronic eligibility checking (EDI207/271), more billing systems are checking a patient's insurance benefits and coverage prior to appointments for services or procedures. While checking eligibility aids in the process of determining a patient's potential financial responsibility without billing codes, place of service, insurance contract pricing, and a determination of in network provider membership, it is not possible to provide an accurate estimate to a patient. Additionally, repetitive treatments on more than one anatomical location on the patient's body are often not estimated. Furthermore, inadequate information about a patient's demographics and insurance can cause billing claims to be uncollectable.

Current billing systems generally lack the option of updating and notifying a patient's medical information to all the medical services providers and legal healthcare organizations on a common electronic platform. Due to absence of such a billing solution, healthcare organizations have an increased delay in patient collections and rising bad debt. Present solutions do not provide estimated charges of patient visit or medical care based on the providers' historical billing codes that they most commonly used for one or a group of diagnosis. Also, none of these solutions coordinate estimates across different legal entities to create a consolidated price estimate for a medical procedure that a patient is scheduled to have. Hence, there is a requirement among users and medical services providers for shared information and notifications on insurance and payment issues in healthcare industry.

### SUMMARY OF THE INVENTION

Aspects of the present invention provides a system and a method for estimating medical billing codes and patient's financial responsibility for patient encounters, procedures, tests, and/or other medical care for a new or existing patient. Aspects of the present invention provides an estimation of the medical billing codes based on the patient's current diagnosis and/or medical problem; and the most frequently used historical billing codes by the patient's medical services provider's that are associated with one or a group of diagnosis and medical problems. Furthermore, a set of customized rules, are incorporated in the system and method of the aspects of the present invention that refine the selection of codes most relevant to the patient's diagnosis or medical problem. In the absence of the most frequently used billing codes for a diagnosis or medical problem, the medical specialty with most frequently used diagnosis and medical problems is selected for the patient. From the final billing codes, patient's financial responsibility is calculated based on the charges mapped with patient's insurance eligibility offered by legal healthcare organizations and the contractual insurance payment allowed amounts as determined by a provider or organization being in-network or out-of-network to generate the consolidated estimate.

An objective of the aspects of the present invention is to provide a system and a method to estimate a patient's billing code(s) for future medical services, by selecting and analyzing a medical service provider's historical billing codes for specific one or a group of diagnosis and medical problems, rather than analyzing billing codes for all the available diagnosis or medical problems.

Another objective of the aspects of the present invention is to estimate billing for a patient's diagnosis and medical problems in case of more than one anatomical location by adding the values of billing codes for each additional location.

Another objective of the aspects of the present invention is to refine the estimated billing codes for a patient's diagnosis and medical problems by filtering the estimated billing codes through a series of customized rules, such as but not limited to, type of visit by the patient, new or existing patient, legal healthcare organizations, patient age, patient gender, duration since last visit, surgical global period, surgical codes, codes bundled together, and other conditional logic.

Another objective of the aspects of the present invention is to automatically share the patient's demographic, insurance, appointment, problem or diagnosis, and type of visit with other organizations, in case the patient procedure involves different legal healthcare organizations to produce an automated final consolidated estimate from a surgical procedure or to collect estimates from different organizations.

### BRIEF DESCRIPTION OF THE DRAWINGS

FIG. 1 illustrates a system to generate billing codes for calculating a consolidated medical bill, in accordance with an embodiment of the present invention.

FIG. 2 illustrates a method showing a flow diagram depicting an encounter of new and existing patients with a system, for storing their demographic information selected on the basis of billing codes and service providers, in accordance with an embodiment of the present invention.

FIG. 3 illustrates a method depicting a flow diagram showing mapping of medical problems to diagnosis and analysis of historical medical information, in accordance with an embodiment of the present invention.

FIG. 4 illustrates a method depicting a flow chart showing analysis of data corresponding to billing claim, by analyzing historical data of a medical services provider, in accordance with an embodiment of the present invention.

FIG. 5 illustrates a method depicting a flow diagram showing generation of final billing codes by a system disclosed in the present invention, applicable under customized billing rules, in accordance with an embodiment of the present invention.

FIG. 6 illustrates a method depicting a flow diagram for automatic calculation of pricing estimates by the system disclosed in the present invention, from the final generated billing codes, in accordance with an embodiment of the present invention.

FIG. 7A illustrates a method depicting a flow diagram showing automatic calculation of patient's financial responsibility by the system, for a patient under medical insurance cover, when medical services provider lies in-network for patient's Legal Healthcare Organization, in accordance with an embodiment of the present invention.

FIG. 7B illustrates a method depicting a flow diagram showing automatic calculation of patient's financial responsibility by the system, for a patient under medical insurance cover, when medical services provider does not lie in-network for patient's Legal Healthcare Organization, in accordance with an embodiment of the present invention.

### DETAILED DESCRIPTION OF THE EMBODIMENTS

In the following detailed description of embodiments of the invention, numerous specific details are set forth in order to provide a thorough understanding of the embodiment of invention. However, it will be obvious to a person skilled in art that the embodiments of invention may be practiced with or without these specific details. In other instances well known methods, procedures and components have not been described in details, so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

Embodiments of the present invention provide a system and a method for estimation of billing codes and calculation of patient's financial responsibility for medical services. Billing codes are the codes, generated by the system of the embodiments of the present invention or manually selected, corresponding to expected medical services. The medical services comprise, but not limited to office visits, medical treatments, tests, and surgical procedures, among others.

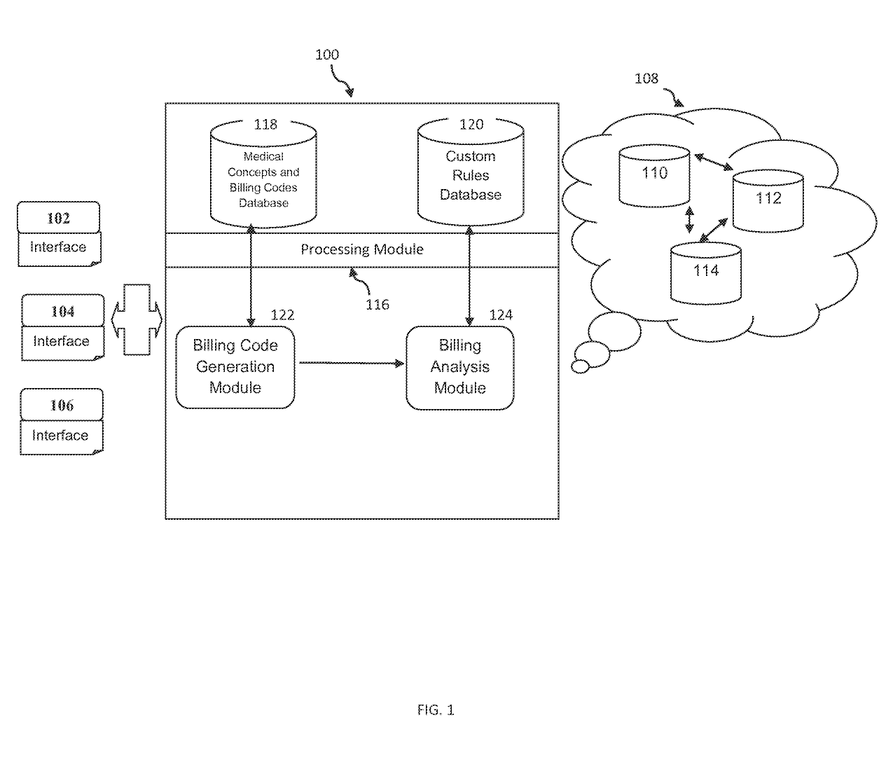

FIG. 1 illustrates a system to generate billing codes for calculating a consolidated medical bill, in accordance with an embodiment of the embodiments of the present invention. According to the embodiments of the present invention, the system 100 may comprise one or more users, including but not limited to a patient 102, a medical services provider 104, a legal healthcare organization 106, and the like. Further, the patient 102 may be an individual, who requires diagnosis for a medical problem and/or treatment for a medical problem. The medical services provider 104 may comprise medical and healthcare providers such as physicians, surgeons, diagnostic specialists, hospitals, clinics, diagnostic centers, among others. The legal healthcare organization 106 may comprise companies that provide legal advices or services for medical needs, such as medical insurance coverage to the patient for their medical expenses.

Enquiring for a medical service, such as patient problems, diagnosis or a treatment, the user may enter a query related to the medical service via a user device, including an interface, into the system 100. Since the system 100 may have three different types of users at a time, therefore FIG. 1 depicts different user devices for different users. Depending on the type of user, the medical requirements may vary. Therefore, a patient 102, a medical services provider 104, and a legal healthcare organization may utilize the corresponding user devices 102A, 104A, and 106A to enter corresponding query into the system 100. The user devices 102A, 104A and 106A may include, without limitation, a smart phone, a tablet, a computer, a laptop, among others. Hereinafter, the patient 102, the medical services provider 104 and the legal healthcare organization 106 may be collectively referred to as “user(s)” unless otherwise referred individually. In an embodiment of the present invention, the system 100 may reside on the user device (102, 104, and 106). In another embodiment of the present invention, the system 100 may reside on a server device 108.

The information entered into the system 100 by the users, namely the patient 102, the medical services provider 104 and the legal healthcare organization 104, is stored in one or more databases stored on the server device 108. The server device 108 maintains information databases, namely a patient database 110, a medical services provider database 112, and a legal healthcare organization database 114 that store information related to patients 102, medical services provider 104 and legal healthcare organizations 106 respectively. The server device 108 automatically shares the information among the databases 110, 112, 114, the system 100 and with the user devices 102A, 104A, 106A.

The patient database 110 stores the detailed information about each patient respectively who uses the system 100 to enquire for his/her desired medical service. The patient information may include and is not limited to patient demographics (for example age, gender, predisposition to diseases, among others), patient medical insurance eligibility (such as copay, coinsurance, deductibles among others), existing medical insurance cover, discount after the first appointment or the first medical service, among others. Also the patient database 110 may store historical billing codes that are most frequently used by a patient for a medical service.

The medical services provider database 112 may store provider's information such as but not limited to list of all the visiting patients with their details, prior medical concepts and diagnostic codes generated by the medical services provider for the patients, corresponding billing codes generated, billing discounts previously offered to the patients, information about the medical insurance coverage for the patients, maintaining information for in-network legal healthcare organizations, medical specialty information, and the like. Previously billed medical concepts and billing codes may be referred to as historical data. Historical data helps in determining most frequently used medical concepts and billing codes for a particular patient.

Further, the system 100 maintains one or more databases and a processing module 116. The databases in system 100 may include medical concepts and billing codes database 118, and a custom rules database 120. The medical concepts and billing codes database 118 may comprise diagnostic codes and codes corresponding to the medical services disclosed or entered by the patients, wherein the medical services may include consultation, diagnosis, treatment, surgery, among others. In an embodiment of the invention, medical concepts and billing codes database 118 may also comprise basic or default billing codes that determined the default fees or costs incurred by the patients in a medical service. These costs may be helpful in calculating a final billing estimate incurred by a patient for a medical service.

The custom rules database 120 includes rules or guidelines regarding parameters of generating billing codes depending on factors such as but not limited to patient demographics (for example age, gender, predisposition to diseases, among others), patient medical insurance eligibility (such as copay, coinsurance, deductibles among others), existing medical insurance cover, discount after the first appointment or the first medical service, among others.

Every query or detailed information entered by the users into the system 100 is stored in the corresponding database 110, 112 and 114 residing in the server device 108. Further, the output from the system 100 is also stored respectively in an appropriate database 110, 112, and 114 in the server device 108. As soon as a user, such as a patient 102, enters a query into the system 100, the information gets stored in the patient database 110. Thereafter, the processing module 116 analyses the query entered by the patient 102, and identifies keywords related to the medical problems/situation entered by the patient 102. Further, the processing module 116 scrutinizes the medical concepts and billing codes database 118, and identifies a relevant medical concept(s) providing detailed information about the medical problem/situation queried by the patient 102.

Furthermore, the processing module 116 identifies a billing code(s) corresponding to the medical concept identified in order to determine a cost incurred from the medical service/situation to be availed. The determination of the medical codes and the corresponding billing codes may be done by a billing code generation module 122 of the processing module 116. Thereafter, a billing analysis module 124 extracts appropriate customized rules or guidelines from the custom rules database 120 that are to be applied on the billing codes identified by the billing code generation module 122.

The billing analysis module 124 analyses the identified billing codes along with the applicable custom rules to generate a consolidated final billing claim estimate and patient's financial responsibility. In an embodiment of the present invention, the billing analysis module 124 also takes historical data, including billing codes from the medical services provider database 112, and/or legal healthcare organization database 114, to determine a consolidated billing claim estimate and patient's financial responsibility. In an embodiment, the billing analysis module 124 may check the historical data for a particular patient 102 stored in the patient database 102 along with the present billing code generated and the applicable custom rules to determine a consolidated billing claim estimate and patient's financial responsibility. Consequently, the system 100 provides a final consolidated billing claim estimate detailing the costs incurred by the patient 102 for his/her desired medical service to be availed after applying the patient's medical insurance details that are kept within the patient database 110.

More particularly, after receiving a medical query from the patient 102, the system fetches relevant medical concepts describing the medical services desired by the patient 102 from the medical concepts and billing codes database 118 and also corresponding billing codes representing price charges to be incurred in the medical services. Medical services may include and are not limited to medical consultation, diagnosis, treatment, surgery, medication and the like. The system 100 determines relevant billing codes depending on the type of patient, for example a new or an existing patient, and the type of appointment wished by the patient, such as a surgery, a consultation, a medical check-up and the like. These billing codes are hereinafter referred to as valid billing codes depending on the appointment type.

The system 100 also determines “default” billing codes that are to be incurred by the patient for availing the medical services, he/she desires. These are hereinafter referred to as “chargeable billing codes”. To determine this, the system 100 considers the medical query and generates related medical concepts. For the medical concept, a medical diagnosis is determined, and added to the patient's list of diagnosis. If more than one new problem is entered by the patient, the system 100 repeats the process to add the relevant medical diagnosis and concepts in the patient's list. In an embodiment, the system 100 verifies whether one or group of diagnosis is with or without the patient's gender and age.

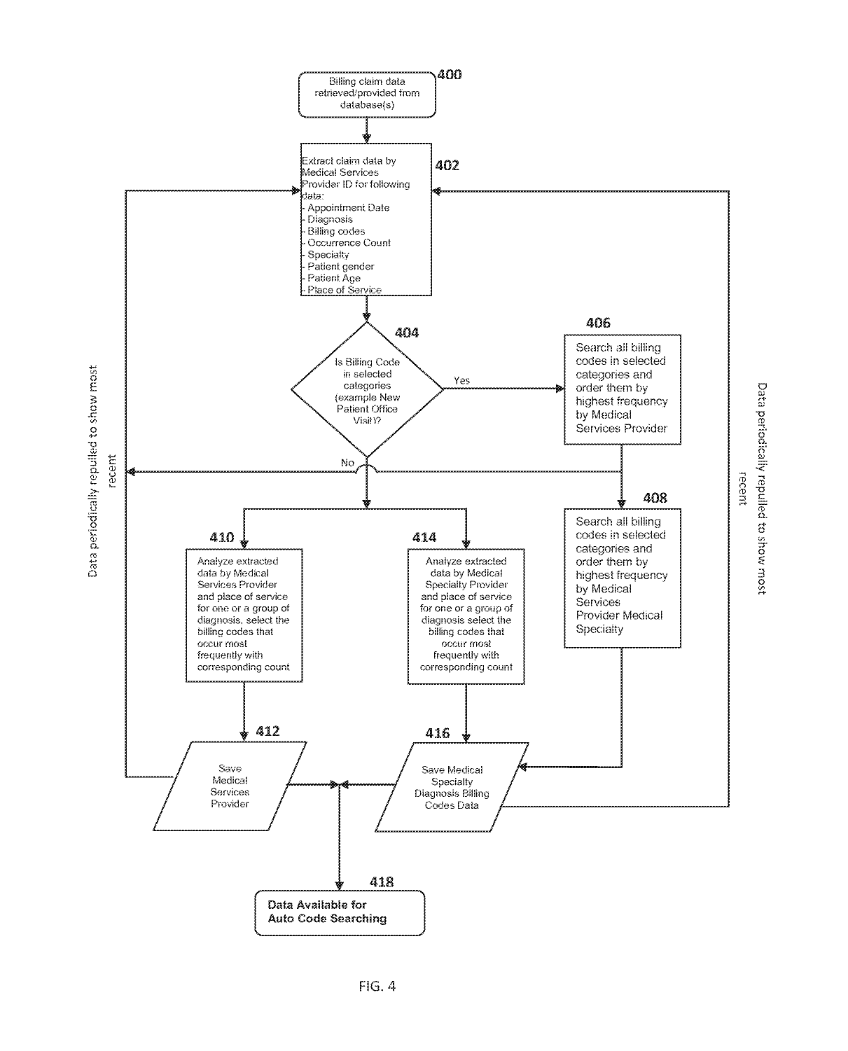

After every medical concept has been assigned one or group diagnosis, the system 100 searches whether the determined group of diagnosis appears in the list of diagnosis billing codes of the medical services provider 104. If yes, the system 100 fetches the billing codes from the chargeable billing codes, as will be described further in conjunction with FIG. 4.

On the other hand, if the group of diagnosis does not appear in the list of diagnosis billing codes of the medical services provider 104, the system 100 then searches for the group of diagnosis in the list of diagnosis billing codes of medical specialty of medical services provider 104. If found, the system fetches the billing codes from the medical specialty's list and further refines the billing codes to get the default chargeable billing codes. On the other, if not found in the medical specialty, the system 100 searches for the individual diagnosis to be present in the list of diagnosis billing codes of the medical services provider 104. If the individual diagnosis is present in the medical services provider's list, the system 100 fetches the billing codes from the medical services provider's list and further refines the billing codes to get the default chargeable billing codes. While if still not found, the system 100 searches through a historical data of medical concepts and billing codes of the medical services provider 104 to find whether the determined individual diagnosis is present in the historical data. When found, the system 100 prompts medical services provider 104 and/or the patient 102 that a group match for the individual diagnosis is found and further displays billing codes to add for refining.

In the other situation, if the individual diagnosis is not found in the historical data, then the system 100 searches the individual diagnosis in the list of diagnosis billing codes of medical specialty of medical services provider 104. If found, the system fetches the billing codes from the medical specialty's list and further refines the billing codes to get the default chargeable billing codes. On the other, if not found in the medical specialty, the system 100 notifies the medical services provider 104 that no estimate codes are found. In an embodiment, the system 100 may also suggest that the diagnosis and the related billing codes needs to be added, when no billing code could be found for one ore group of diagnosis. In this way, the system 100 generates one or more chargeable billing codes for one or group of diagnosis from the default billing codes of the medical services provider 104 or its medical specialty.

The system 100 also goes through the historical data of the medical services provider 104. The historical data includes previously billed medical concepts and billing codes that are claimed by the patients. The system 100 arranges all the billing codes appearing in selected query categories in the order of the frequency of occurrence. Query categories includes and are not limited to encounter date, diagnosis, billing codes, quantity units, specialty, place of service, patient gender, patient date of birth and the like. The system 100 may arrange from highest number of occurrence to the lowest, or vice-versa. In an embodiment, the system 100 arranges all the billing codes appearing in selected query categories in the order of the frequency of occurrence for medical specialty provider.

In the situation when the query categories do not have any billing codes, the system 100 analyses the historical data of the medical services provider 104 for individual or group of diagnosis and selects the billing codes that occur most often with corresponding quantity that occurs most often for each code. In an embodiment, the system 100 analyses the historical data of the medical specialty of the medical services provider 104 for individual or group of diagnosis and selects the billing codes that occur most often with corresponding quantity that occurs most often for each code. Further, the most frequently occurring billing codes are saved for the medical services provider 104 and the medical specialty.

In an embodiment, the saved data is available for code searching. In another embodiment, the historical data is periodically re-pulled to determine the most frequently occurring billing codes present currently.

Further, to refine the chargeable billing codes determined hereinabove, the system 100 compares the valid billing codes, chargeable billing codes and the most frequently occurring historical billing codes. The system 100 maps the valid billing codes with the most frequently occurring historical billing codes for one or group of diagnosis, and verifies whether the most frequently occurring historical billing codes occur as valid billing codes also. If yes, the valid billing codes mapped with the most frequently occurring historical billing codes are further mapped with the chargeable billing codes. Thereafter, the chargeable billing codes mapped with the valid billing codes are screened out and the chargeable billing codes with the highest frequency of occurrence is selected, while removing all other valid billing codes.

Further, the system 100 determines whether any diagnosis has more than one anatomical location area listed, and whether they are surgery or medication category codes. Therefore, the system 100 duplicates billing codes for same diagnosis for each anatomical area and remove any other billing codes that are duplicated. If there is only one anatomical location, the system 100 finds any custom rules to be applicable on the chargeable billing codes and extract or add billing codes as per the defined custom rule. Rule attributes may include and are not limited to gender, age, payer billing codes allowed, codes that cannot be billed together, diagnosis, discontinued codes, last surgical date and code, and amount of days since last encounter or medical care and the like. Subsequently, final chargeable billing codes list is generated by the system 100 using the most frequently occurring historical data and custom rules.

In case the valid billing codes are not present in the most frequently occurring historical data, then the system 100 determines whether any diagnosis has more than one anatomical location area listed, and whether they are surgery or medication category codes, and follows the same procedure as described above.

Addition of new user information and the analyzed output from the system 100 are automatically shared among the databases 110, 112 and 114 in the server device 108 and the user devices 102A, 104A, 106A. In an embodiment, the users 102, 104, 106 receive notification alerts for updated information through but not limited to email, text message, voice message, or call, among others.

Therefore, the system 100 of the embodiment of the present invention provides a consolidated estimation of billing codes and patient's financial responsibility for medical services availed and/or to be availed by a patient 102. Furthermore, the system 100 allows users such as patients 102, medical services provider 104 and legal healthcare organizations 106 to provide input and access information among them. The system 100 also provides opportunity to the patients 102 to be informed about the medical services provider 104 and approximate estimate of the cost of availing their services. The system 100 further provides information to the patients 102 about the medical insurance coverage offered by the legal healthcare organizations 106 and related information that let the patients 102 make an informed decision about medical insurance coverage to opt for. In addition, the present system 100 also allows the medical services provider 104 and the legal healthcare organizations 106 to connect, link and market their services for the patients 102. Therefore, the system 100 maintains connectivity between the patients 102, medical services provider 104 and legal healthcare organizations 106 and keeps informing each one of them for their desired requirements.

In an embodiment, the patient may request from one or more desired medical services providers or legal healthcare organizations to provide an estimate of billing codes and financial responsibility by selecting them, and the processing module further automatically shares the patient's payer information, type of visit and problems or diagnosis with the medical services providers or legal healthcare organizations. The processing module further requests payer benefits information from the medical services providers or legal healthcare organizations, creating an estimate of billing codes and patient responsibility for that selected facility. Thereafter, the medical services providers or legal healthcare organizations review the estimates. The system 100 sends the estimate to the patient, where the patient can accept one of the estimates and request the appointment.

In an embodiment, the medical services provider for every diagnosis or group of diagnosis associated with the most frequently used billing codes is compared to an average medical services provider medical specialty for every diagnosis or group of diagnosis associated with the most frequently used billing codes, the medical services provider or patient is identified about the different codes and are alerted of the difference.

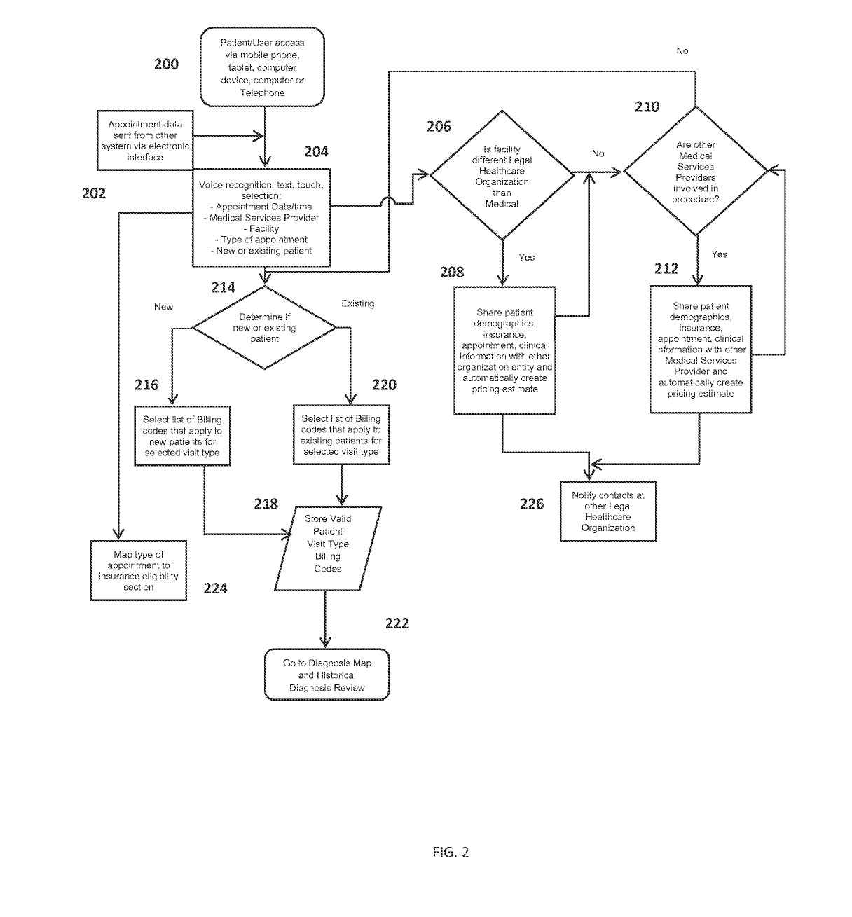

FIG. 2 illustrates a method showing a flow diagram depicting an encounter of new and existing patients with a system, for storing their demographic information selected on the basis of billing codes and services providers, in accordance with an embodiment of the present invention. A user, such as a patient 102, a medical services provider 104 and a legal healthcare organization 106, accesses the system 100 via a user device 102A, 104A, 106A, to enter a query related to a desired medical service and to make an appointment between the desired users, in step 200. The user device may include but not limited to mobile phone, tablet, telephone, laptop or computer. In an embodiment, appointment data from any other system may also be sent, in step 202, via the user device 102A, 104A, 106A. In an embodiment of the present invention, the query is received by the system 100 through but not limited to voice recognition, text, touch, mouse selection and the like. In a further embodiment of the present invention, the system 100 asks the user, such as the patient 102, to fill in a number of query categories, such as selection of an appointment date, time, a medical services provider 104/facility, type of appointment, a legal healthcare organization 106, whether he/she is a new patient or existing patient 102, and the like, in step 204.

In yet another embodiment, when the user is a medical services provider 104, the system 100 may provide the medical services provider 104 a provision to add information about their patient's treatment, medical concepts and billing codes, costs, networking with insurance organizations for payment, interacting with patients for updated information on their demographics and the like information. Further, in an embodiment, when the user is a legal healthcare organization 106, the system 100 may provide an interface for them to network with the medical services provider 104 and also plan their legal medical policies depending on the mutual benefits; to interact with new and existing patients and inform them about new or updated legal medical policies; to market their legal services to both the patients 102 and the medical services provider 104; to update their databases with the required information 114, and the like.

After a successful selection of medical appointment at step 204, the type of appointment may be mapped in step 224 to insurance eligibility section for the patient 102. This may be done to provide the patient 102 with the appropriate insurance according to his/her eligibility that may be determined by his/her demographics.

In an embodiment, after entering a facility in the step 204 by the user, the system 100 determines in step 206 if the medical facility is different legal healthcare organization 106 than the medical services provider 104 or not. If the medical facility is different, the system 100 in step 208 shares the patient's 102 demographics, insurance, appointment details, clinical information with the legal healthcare organization 106 connected with the system 100 and automatically creates a pricing estimate, as described earlier in conjunction with FIG. 1. The system 100 then, in step 226, notifies contacts lying in the network at other legal healthcare organizations 106.

Price estimate is coordinated across all the medical services provider 104 and legal healthcare organization 106 connected with the system 100. In an embodiment, a database, such as the National Provider Identifier, provides mapping of service providers, or practitioners such as physicians, surgeons, diagnostic specialists, medical professionals to medical organizations such as hospitals, clinics, diagnostic centers. These service providers or practitioners may also serve as a medical facility for the patients, at step 204.

Further, in case the medical facility entered in step 204 is not different legal healthcare organization 106 than the medical services provider 104, then the system 100 determines in step 210 if other medical services provider 104, than the one listed in step 204, are involved in the medical procedure or not. In case other medical services provider 104 are involved in the procedure, the system 100 according to step 212 shares patient's demographics, insurance, appointment, clinical information with the other medical services provider 104 and automatically creates a pricing estimate, as described earlier in conjunction with FIG. 1. The system 100 then, at step 226, notifies contacts at legal healthcare organizations 106.

On the other hand, if other medical services provider 104 is not involved in the medical procedure, then the system 100, in step 214, determines if the patient 102 is new or existing. In case the patient 102 is new, the system 100 as per step 216 selects a list of billing codes applicable to new patients 102 for selected visit type that further means the type of medical service the patient requires to treat their problems or diagnosis. These selected billing codes may be hereinafter termed as valid patient visit type billing codes. Thereafter, at step 218, the valid patient visit type billing codes are stored in patient database 110 for that particular new patient. Also, as soon as a new patient enters into the system 100, the system 100 stores the medical problems/situation along with the diagnosis map in order to create a historical diagnosis for that new patient that further may be used in estimating a billing cost incurred in using the medical facilities.

In the other situation when the patient is an existing patient 102, the system 100 selects a list of billing codes that apply to the existing patients 102 for the selected visit/appointment type, according to step 220. Further, the valid patient visit type billing codes are stored in patient database 110 for that particular existing patient, at step 218. Later, a diagnosis map corresponding to the patient's 102 medical problem and historical diagnosis are considered in step 222, in order to analysis the earlier medical problems for the patient 102 and estimate a consolidated bill for the patient 102.

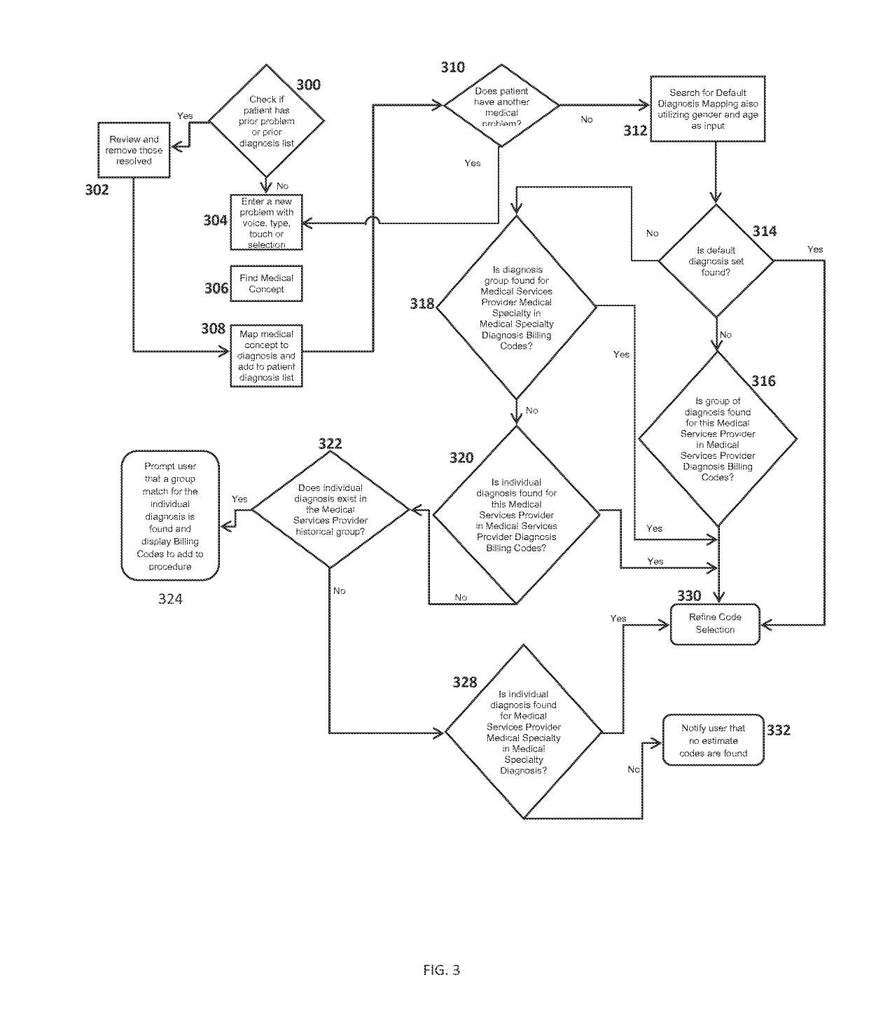

FIG. 3 illustrates a method depicting a flow diagram showing mapping of medical problems to diagnosis and analysis of historical medical information, in accordance with an embodiment of the present invention. The method of FIG. 3 depicts problem mapping and historical diagnosis review, as shown earlier in step 222 of FIG. 2, done after storing a valid patient visit type billing codes. According to the FIG. 3, in step 300, the system 100 checks the presence of one or more lists of prior medical problem and/or a list of prior medical diagnosis for a patient 102. In presence of list of a prior medical problem and/or medical diagnosis, the system 100, in step 302, reviews the lists and removes the medical problems and/or prior medical diagnosis that are resolved. If list of prior medical problem and/or prior medical diagnosis are not present, a new medical problem and/or medical diagnosis is generated in the system 100 through an input means in the user device 102A, 104A and 106A such as but not limited to voice recognition, text, touch, mouse selection, in step 304.

At a next step 306, the system 100 searches for the corresponding medical concept, from the medical concept database 118 that identify the medical problem and/or the medical diagnosis. In an embodiment of the present invention, medical concepts corresponding to medical problem and/or medical diagnosis may include medical codes such as diagnostic codes and codes corresponding to medical services expected to be received by a patient 102. Further, the system 100 maps the medical concept for a medical problem to a suggested diagnosis and adds the medical concept to patient 102 diagnosis list, according to step 308. In an embodiment, when the resolved problems are removed from the system 100 and no new problem is entered, the system 100 may map the reviewed records of medical problem and medical diagnosis, to medical concept and add to patient diagnosis list, thereby updating the list. The system 100, further verifies in the next step 310 if the patient 102 has another medical problem or not. If the patient 102 has another medical problem, the system 100 resumes the steps 304 to 308.

In case the patient 102 does not have another medical problem, the system 100 in step 312 searches for a default diagnosis set of bill codes, in the system 100, corresponding to the diagnosis mapped at the earlier step 308 for the medical concept. In an embodiment, the system 100 may also utilizes patient's gender and age for determining a default set of billing codes for diagnosis. If the default diagnosis set of billing codes is found at step 314, the system 100 proceeds to refine code selection in step 330. On the other hand, if a default diagnosis set of billing codes is not found in the system 100, then the system 100 searches for a group of diagnosis offered by a particular medical services provider 104 of the patient 102, at a step 316. In case, the patient's medical services provider 104 has the group of diagnosis, then the billing codes associated with the group of diagnosis are saved. Thereafter, the system 100 proceeds to step 330 of refine code selection after finding the relevant diagnosis set and its associated billing codes.

As per the step 316, if the relevant diagnosis set is not found in the diagnosis bill codes of medical services provider 104, then the system 100, in step 318, determines whether a medical specialty of the medical services provider 104 has the relevant diagnosis set. In case, a medical specialty is found to have the relevant diagnosis set, then the bill codes associated with the determined medical specialty diagnosis are generated and saved, thereafter continuing to Refine Code Selection (shown by step 330).

On the other hand, if the relevant diagnosis bill code is still not found in the medical specialty, then the system 100, in step 320, searches for individual diagnosis provided by the particular medical services provider 104, and the bill codes associated with the individual diagnosis of the medical services provider 104 are fetched. Thereafter, the system 100 moves to refine code selection at step 330. In case individual diagnosis billing codes are still not found at step 320, then in step 322 the historical diagnosis group of medical services provider 104 is searched. The system 100, in the next step 324 prompts the users 102, 104, 106 that group match for the individual diagnosis is found and the system 100 displays the associated billing codes to add to the subsequent steps of the medical procedure. Whereas, if the individual diagnosis does not exist in the historical group of medical services provider 104, the system 100 identifies if the individual diagnosis is found in medical specialty of the medical services provider 104, and hence in the diagnosis bill codes of the medical specialty. The system 100 proceeds to the step of refine code selection 330, whenever a relevant diagnosis billing code is found.

The system 100, in step 332, notifies the users 102, 104, 106 that no estimate billing codes are available for any of the diagnosis. Therefore, the system 100 successfully identifies a default billing code for a medical problem diagnosis by mapping the diagnosis on the default diagnosis sets of the medical services provider 104, or medical specialty, or individual diagnosis for the medical services provider and also onto historical data of the diagnosis performed for the patients by the medical services provider.

FIG. 4 illustrates a method depicting a flow chart showing analysis of data corresponding to billing claim, by analyzing historical data of a medical services provider, in accordance with an embodiment of the present invention. A user, such as a patient 102, submits required information into the system 100, while entering a medical query. The patient 102 needs to enter information, such as gender, age, appointment type, appointment date, medical diagnosis, and the like in query categories maintained by the system 100. These categories need to be filled by the user, such as patient 102. For calculating a medical claim to be offered to a patient 102, the system 100 analyses data related to the patient 102, such as demographics, medical history, appointments taken, medical services availed or to be availed, and the like. Therefore, the system 100 retrieves, in step 400, data related to calculate a billing claim, from the information stored in the databases (shown by 110, 112, 114, 118, and 120). This billing claim data may help in calculating the cost that is to be claimed by the patient 102.

In an embodiment of the present invention, the system 100, as per step 402, extracts billing claim data according to the medical services provider ID for information such as but not limited to appointment date, diagnosis, billing codes, count for each billing code, specialty, patient gender, patient date of birth, patient age among others. At a subsequent step 404, the system 100 checks if one or more billing code(s) are generated in one or more of the selected categories. The categories checked includes but are not limited to patient 102 being new or existing, type of visit, specialty, gender, age, appointment date, among others (as shown earlier in step 204 in conjunction with the FIG. 2). For example, the system 100 may check whether one or more billing codes have generated in a medical check-up by the medical services provider 104, such as an eye checkup. In an embodiment, the medical services provider 104 may be a medical professional, such as a doctor, or a hospital providing medical services and/or medical health care insurance.

If the billing codes are present in the selected categories, then at step 406, the system 100 searches all billing codes in the selected one or more categories and arranges them in order of the highest frequency of occurrence. For example, the system 100 may look into the historical data of the medical services provider 104 and analyses the number of times the medical services provider 104 has advised for a particular test, such as a blood sugar test in case of appointment visit for a heart disease. Further, in another example the system 100 may look into the historical data of the medical services provider 104 in a particular patient 102 case and analyses what all medical tests, or medication, and the like, the medical services provider 104 has suggested the patient 102 and how many times. Also, all these medical services, such as tests, or medication, are extracted in all or the desired categories. After extracting the medical diagnosis data along with all the billing codes generated by the medical services provider 104 and the number of times these are occurring, the system 102 arranges the billing codes in order of the highest frequency of occurrence.

In an embodiment of the present invention, in step 408, the system 100 also arranges all the billing codes in the selected categories in order of the highest frequency of occurrence by a medical specialty of the medical services provider 104. In an embodiment of the present invention, the billing codes in selected categories may be arranged in increasing order of the highest frequency. In an embodiment of the present invention, the billing codes may be arranged in decreasing order of the highest frequency. In an embodiment of the present invention, the system 100 may repeat the steps from 402 after 406 while extracting and/or being provided with additional billing claim data (shown in step 400). Therefore, while arranging the billing codes in order of their frequency of occurrence, the system 100 looks into the historical data of the medical services provider 104.

On the other hand, in a situation when billing codes are not present in any of the selected categories, the system 100, in a step 410, analyzes the extracted data related to the medical services provider 104 for one or a group of diagnosis, for analyzing a medical claim. Thereafter, the system 100 selects the billing codes that occur most frequently with their corresponding count for the one or group of diagnosis. In a subsequent step 412, the system 100 saves the diagnosis bill codes with the highest count for the medical services provider and place of service 104. The data is periodically re-processed from step 402 to show the most recently updated information. This may be important because, with the advent of time, the frequency of occurrence of the billing codes change and also, the billing codes themselves may be updated with time changing the costs incurred for medical services.

In an embodiment of the present invention, when billing codes are not present in the selected categories, the system 100, in step 414, also analyzes extracted data related to a medical specialty of the medical services provider and place of service 104 for one or a group of diagnosis. The system 100, then, selects the billing codes that occur most frequently with their corresponding count for the one or group of diagnosis. At step 416, the system 100 saves the diagnosis bill codes with the highest count for the medical specialty. The saved data is stored by the system 100 and is available for auto code searching, in step 418. The data is periodically re-processed from step 402 to show the most recently updated information.

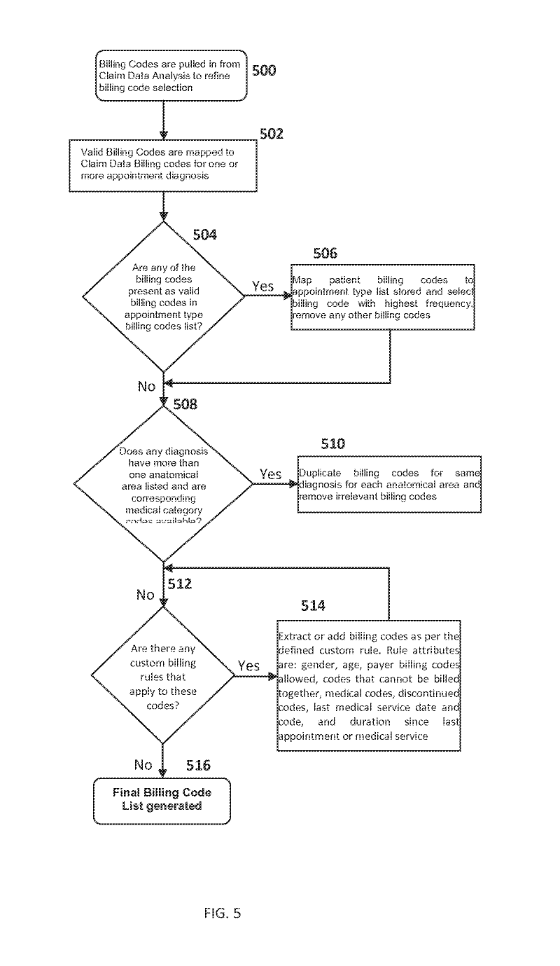

FIG. 5 illustrates a method depicting a flow diagram showing generation of final billing codes by a system disclosed in the embodiment of the present invention, applicable under customized billing rules, in accordance with an embodiment of the present invention. At a step 500, the system 100 extracts and utilizes the resulting billing codes from claim data analysis of the method described earlier in FIG. 4, to refine billing code selection. In a further step 502, the valid bill codes stored corresponding to a query category, such as a patient visit type, are mapped to claim data billing codes for one or more diagnosis appointment. The valid billing codes are generated earlier in the method described by FIG. 2. It may be analyzed by mapping the valid bill codes with the claim data billing codes that which are those claim data billing codes that are also occurring in the valid bill codes. The valid bill codes represents the bill codes that are applicable to a particular patient 102 according to a medical services provider 104 taking into consideration the updated billing codes, the historical data of the medical services provider 104 for the patient 102, the medical services for which the patient 102 has come to avail, the type of appointment visit, the diagnosis, treatment, medication, etc. suggested by the medical services provider 104 along with other necessary factors. Therefore, the valid codes are generated by the medical services provider 104 for a particular patient 102, and are the updated billing codes, removing the data that has gone obsolete with time.

The system 100, in a following step 504, determines if the billing codes generated from the claim analysis are present in valid billing codes in the selected query category. In an embodiment, the billing codes may be mapped with the valid bill codes in appointment type billing codes list. If the valid bill codes are present, then the system 100, in step 506, maps patient billing codes to the list of billing codes stored related to the selected category, such as the appointment type list. Further, the system 100 selects billing codes with the highest frequency occurring in the selected category and removes the rest of the billing codes from the list.

On the other hand, if the valid codes are not found at the step 504, the system moves to a step 508. Also, after selecting the billing codes with the highest count in the category and removing the rest of the billing codes from the list at the 506, the system 100 proceeds to a next step 508, wherein it is determined if any of the diagnosis involves more than one anatomical area listed in the information entered by the user, either patient 102, or medical services provider 104, or legal healthcare organization 106. The medical codes, for all the anatomical areas are fetched, when one diagnosis type has more than one anatomical area. Subsequently, when the diagnosis has more than one anatomical area listed, then the system 100, in step 510, duplicates the billing codes for the same diagnosis for each anatomical area and removes irrelevant billing codes.

In a contrasting situation, when the system determines that none of the diagnosis involves more than one anatomical area, therefore, in step 512, the system 100 further determines if any custom billing rules are present that apply to the billing codes generated at the step 506. According to the custom rules, the system 100 in step 514, extracts or adds billing codes as per the defined custom rule. In an embodiment of the present invention, the rule attributes are but not limited to gender, date of birth, age, billing codes allowed to be claimed by legal healthcare organization 106 as payer, codes that cannot be billed together, relevant medical codes, discontinued codes, last medical service date and medical code, duration since last appointment and/or medical service. The step 514 is repeated as per additional custom rules. Subsequently, a final billing code list is generated in step 516.

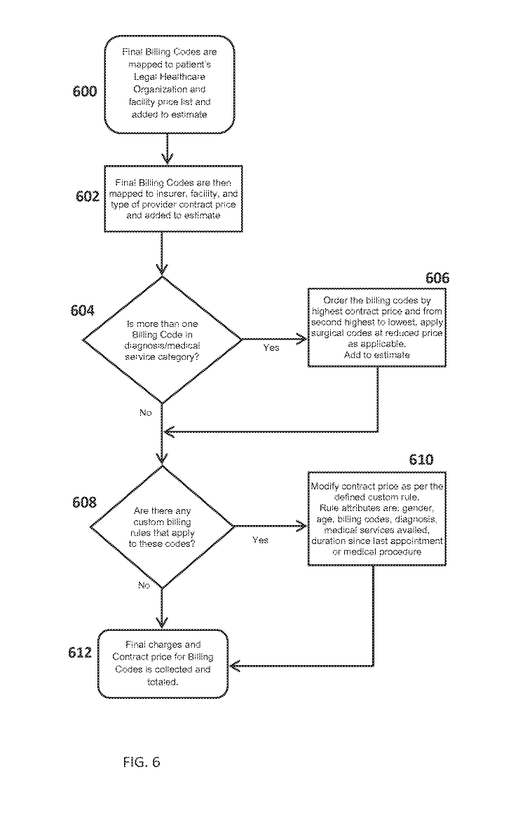

FIG. 6 illustrates a method depicting a flow diagram for automatic calculation of pricing estimates by the system disclosed in the embodiment of the present invention, from the final generated billing codes, in accordance with an embodiment of the present invention. The system 100 utilizes the final billing codes received from the method described earlier in FIG. 5 for calculating price estimates to be offered to the patient 102. The system 100, in a step 600, maps the final billing codes, generated at step 516 in earlier FIG. 5, to the patient's 102 legal healthcare organization 106 and medical services provider's 104 price list. In an embodiment of the invention, the system 100, in step 600, maps the final billing codes generated in step 516 in earlier FIG. 5 to the patient's 102 payer and medical services provider's 104 price list. In an embodiment of the present invention, the system 100, in step 600, maps the final billing codes, generated in step 516 in earlier FIG. 5, to the patient's 102 insurer and medical services provider's 104 price list. In an embodiment of the present invention, the medical services provider 104 may provide medical insurance coverage to the patient 102.

In step 602, the final billing codes are mapped to the contract price corresponding to the type of medical services provider 104 and legal healthcare organization 106. In an embodiment of the present invention, the contract price is the final consolidated price charged to the patient 102 for the medical services availed or to be availed. After mapping the billing codes with corresponding parameters at step 600 and step 602, the price value is added to the estimate.

The system 100 may be incorporated, according to an embodiment of the invention, with custom rules such as but not limited to provision of offers and discounts to patients 102 on availing diagnostic or medical services. In an embodiment of the present invention, the system 100 may be incorporated with custom rules such as but not limited to provision of offers and discounts to patients 102 on availing medical services, such as treatment, therapy, surgery, and the like. In step 604, the system 100 determines the presence of more than one billing code in diagnostic services and/or medical services. In presence of such billing codes, the system 100 in step 606, orders the billing codes by highest to lowest contract price and apply medical concepts such as but not limited to diagnostic codes, surgical codes among others, at reduced price as applicable.

In case, there are no billing code(s) in diagnostic services and/or medical services, then the system 100 moves to step 608. Also, after ordering the billing codes by highest to lowest contract price and applying medical concepts, the system 100 proceeds to the next step 608 to determine if any other custom billing rules apply to the billing codes identified. The system 100 modifies the contract price as per the defined custom rules, in step 610. In an embodiment of the present invention the rule attributes are but not limited to gender, date of birth, age, legal healthcare organization's 106 billing codes, diagnosis, medical services availed, duration since last appointment, duration since last medical procedure, among others. Subsequently in a step 612, final charges and contract price corresponding to the billing codes are collected and totaled.

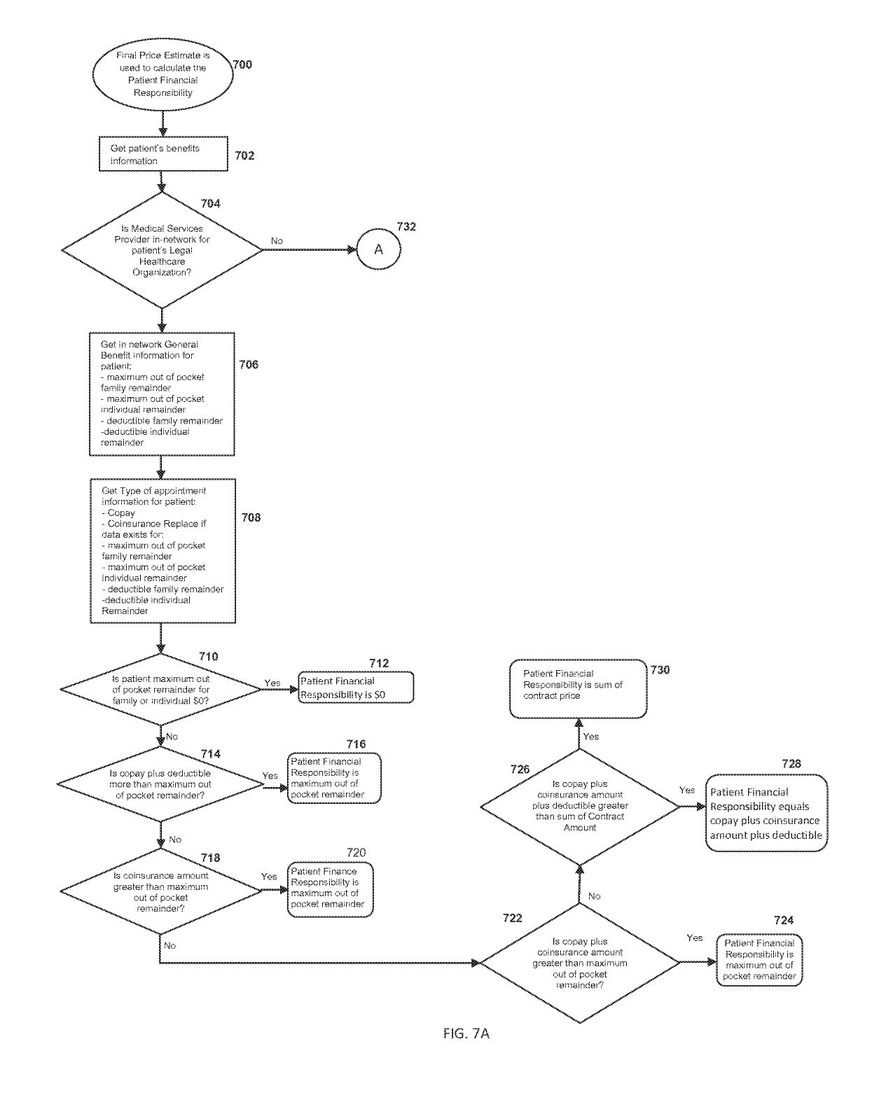

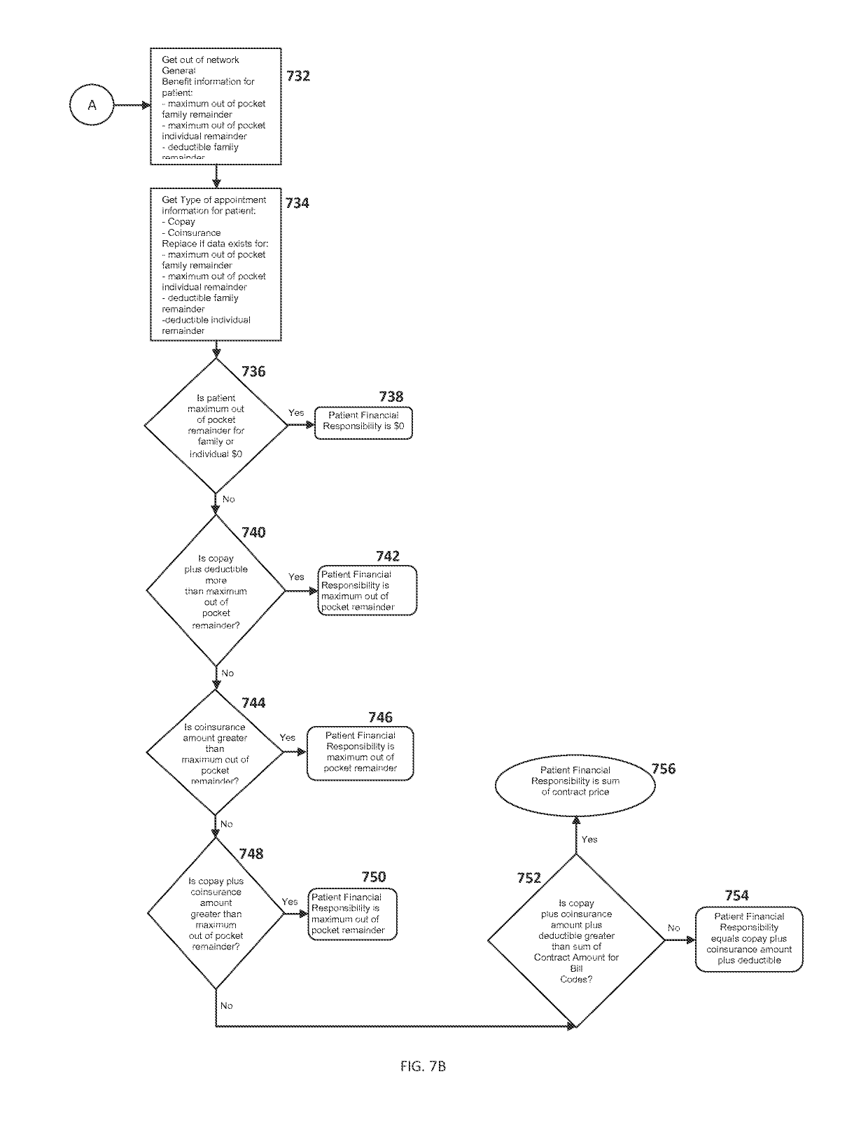

FIG. 7(A) illustrates a method depicting a flow diagram showing automatic calculation of patient's financial responsibility by the system, for a patient under medical insurance cover, when medical services provider lies in-network for patient's Legal Healthcare Organization, in accordance with an embodiment of the present invention. And FIG. 7(B) illustrates a method depicting a flow diagram showing automatic calculation of patient's financial responsibility by the system, for a patient under medical insurance cover, when medical services provider does not lie in-network for patient's Legal Healthcare Organization, in accordance with an embodiment of the present invention. For the calculation of patient responsibility, in step 700, the system 100 utilizes final price estimate data that is determined earlier in FIG. 6. Thereafter, the system 100 extracts information on the benefits to be received by the patient 102 through the medical insurance coverage plan, in step 702. The system 100, in step 704, determines if the medical services provider 104 is in the network of legal healthcare organization 106 or not. In case the medical services provider 104 is not in the network of legal healthcare organization 106, lies out of network of the legal healthcare organization 106, then the system follows “A”, i.e. step 732 of FIG. 7(B).

In case the medical services provider 104 and legal healthcare organization 106 are in-network, the system 100, according to a step 706 gets in-network general benefit information for the patient 102. In an embodiment of the present invention, the general benefit information for patient 102 includes but not limited to maximum out of pocket family remainder, maximum out of pocket individual remainder, deductible family remainder, and deductible individual remainder, among others. After this, the system 100, in a step 708, analyzes the information on a type of appointment of the patient 102, for which the medical insurance coverage provides benefits to the patient 102. In an embodiment of the present invention, the type of appointment of patient 102 that may be covered under medical insurance includes but not limited to copay, coinsurance, among other plans. The system 100 replaces the previous data related to medical insurance cover of patient's 102 appointment type with new information according to the present billing codes. In an embodiment of the present invention, the system 100 replaces data, if available, for but not limited to maximum out of pocket family remainder, maximum out of pocket individual remainder, deductible family remainder, and deductible individual remainder, among others.

In an embodiment of the present invention, the medical services provider 104 may enter custom rules in the system 100 to offer reduction in contract price for medical services subsequent to the first medical service availed by the patient 102.

In an embodiment of the present invention, the legal healthcare organization 106 may enter custom rules in the system 100 to offer discounts and/or offers on medical insurance coverage.

The method depicted in FIG. 7 illustrates, according to an embodiment of the present invention, an example of patient responsibility calculation for in-network and out of-network medical services providers 104 and legal healthcare organizations 106.

According to an embodiment of the present invention, for in-network medical services providers 104 and legal healthcare organization 106, the system 100 in step 710, determines if the maximum out of pocket remainder for family is $0. In an embodiment of the present invention, the system 100 determines if the maximum out of pocket remainder for individual is $0. If the remainder in such cases is $0, the patient's financial responsibility calculated by the system 100 is $0, as shown in step 712. If the maximum out of pocket remainder in not $0, then in a series of subsequent steps, the system 100 calculates patient's financial responsibility on various parameters in accordance with the medical insurance coverage availed by the patient 102.

In step 714, the system 100 determines if the value of copay plus deductible more than maximum out of pocket or not. If the copay plus deductible amount is more than maximum out of pocket, the system 100, in step 716, calculates patient's financial responsibility equal to maximum out of pocket remainder. If the copay plus deductible amount is not more than maximum out of pocket remainder, the system 100 determines if the coinsurance amount greater than maximum out of pocket remainder or not, in step 718. In case the coinsurance amount is greater than the maximum out of pocket remainder, the patient's financial responsibility, as per step 720 is maximum out of pocket remainder. If the coinsurance amount is not greater than maximum out of pocket remainder, the system 100 in step 722 determines if the copay plus coinsurance amount is greater than maximum out of pocket remainder. If the copay plus coinsurance amount is greater than maximum out of pocket remainder, the system 100 calculates in step 724, the patient's financial responsibility equal to maximum out of pocket remainder. If the copay plus coinsurance amount is not greater than maximum out of pocket remainder, the system 100, in step 726, determines if copay plus coinsurance amount plus deductible greater than sum of contract amount. If the copay plus coinsurance amount plus deductible is not greater than sum of contract amount, the system 100 calculates patient's financial responsibility in step 728 as equal to copay plus coinsurance amount plus deductible. In case the copay plus coinsurance amount plus deductible is greater than sum of contract amount, the system 100 calculates patient's financial responsibility in step 730 equal to the sum of contract price.

According to FIG. 7(B), the system 100 calculates the patient's financial responsibility in case the medical services provider 104 and legal healthcare organization 106 are out-of network with each other. The system 100 considers general medical insurance benefit information for patient 102, in step 732, represented by “A” in FIG. 7(B). In an embodiment of the invention, the general medical insurance benefit information includes but not limited to maximum out of pocket family remainder, maximum out of pocket individual remainder, deductible family remainder, and deductible individual remainder. Thereafter, in step 734, the system 100 analyzes information on type of appointment, for patient 102, for which the medical insurance coverage may provide benefits to the patient 102. In an embodiment of the invention, the information on type of appointment includes but not limited to copay, coinsurance, among others. In an embodiment of the present invention, the system 100 replaces data, if available, for but not limited to maximum out of pocket family remainder, maximum out of pocket individual remainder, deductible family remainder and deductible individual remainder, among others.

In a next step 736, according to an embodiment of the present invention, the system 100 determines if the value of patient 102 out of pocket remainder for family is $0. In an embodiment of the present invention, the system 100 determines if the value of patient 102 out of pocket remainder for individual is $0. If the value of maximum out of pocket remainder is $0, the system 100, calculates patient's financial responsibility in step 738 as $0. Whereas, if the value of maximum out of pocket remainder is not $0, the system 100 determines if copay plus deductible is more than maximum out of pocket remainder, in step 740. The system 100 calculates patient's financial responsibility as equal to maximum out of pocket remainder, in step 742, if copay plus deductible is more than maximum out of pocket remainder.

On the other hand, if the copay plus deductible is not more than maximum out of pocket remainder, then the system, at step 744, determines whether a coinsurance amount is greater than maximum out of pocket remainder. If the coinsurance amount is greater than maximum out of pocket remainder, then the system 100 calculates patient's financial responsibility as equal to maximum out of pocket remainder, in step 746. In the other case, the coinsurance amount is not greater than maximum out of pocket remainder, then the system 100 determines if copay plus coinsurance amount is greater than maximum out of pocket remainder, in step 748. If copay plus coinsurance amount is greater than maximum out of pocket remainder, then the patient's financial responsibility is calculated, in step 750, to be maximum out of pocket remainder.

In case copay plus coinsurance amount is not greater than maximum out of pocket remainder, then the system 100, in step 752, determines if copay plus coinsurance amount plus deductible is greater than sum of contract amount for billing codes. If copay plus coinsurance amount plus deductible is greater than sum of contract amount for billing codes, the patient's financial responsibility is calculated to be the sum of contract price, according to step 756. If copay plus coinsurance amount plus deductible is not greater than sum of contract amount for billing codes, then the patient's financial responsibility is calculated to be copay plus coinsurance amount plus deductible, as per step 754.

Therefore, the embodiment of the present invention provides a system and methods for calculating billing estimates and patient responsibility for the services availed or to be availed by patients from medical services providers and legal healthcare organizations. Further, the embodiment of the present invention provides a platform where patients, medical services providers and legal healthcare organizations may connect and offer mutual benefits to each other.

We claim:

1) A system for estimating final billing codes and financial responsibility to be incurred by a patient for utilizing at least one medical service offered by at least one medical services provider or organization, the system comprising:
a medical concepts and billing codes database storing a list of medical concepts representing a plurality of medical problems/services for the at least one medical services provider and corresponding billing codes yielding default costs chargeable for availing the medical services; and
a processing module to estimate the final billing code, yielding cost of services offered to the patient for the one or group of medical problems/services, by:
generating one or more valid billing codes that are to be charged to the patient corresponding to the one or group of medical problems/medical services depending on new or existing patient and medical appointment type;
searching a historical data of billing codes of the medical services provider and place of service for identifying most frequently occurring historical billing codes;
verifying whether the valid billing codes are present in the list of most frequently occurring historical billing codes of the medical services provider;
extracting one or more billing codes, chargeable to the patient corresponding to the one or group of medical problems/medical services, from the medical concepts and billing codes database maintained by the at least one medical services provider;
mapping the valid billing codes that are present in the most frequently occurring historical billing codes, with the chargeable billing codes applicable to the patient at a specified place of service for one or group of medical problems/services;
selecting the mapped chargeable billing codes with the highest number of occurrences for the one or group of medical problems/services, while removing all other valid billing codes to obtain the final billing codes for the patient; and
wherein the historical data includes previous billing codes and medical diagnosis and procedures generated by the medical services provider for one or more medical services.

2) The system as claimed in claim 1, wherein the system further comprises a custom rules database storing a set of custom rules applicable on the identified billing codes for availing the medical services by the patient in order to estimate a final billing code.

3) The system as claimed in claim 2, wherein the processing module further applies the custom rules on the mapped chargeable billing codes along with the patient's demographics entered in a medical insurance plan to determine the financial responsibility of the patient.

4) The system as claimed in claim 1, wherein the processing module for estimating the final billing code further verifies whether the valid billing codes have more than one corresponding anatomical location, when valid billing codes are not present in the list of most frequently occurring historical billing codes; duplicating the billing codes for same medical diagnosis for each anatomical area; and removing other billing codes that should not be duplicated.

5) The system as claimed in claim 1, wherein the final billing code is queried against a contract price list of patient's legal healthcare organization, and/or medical services provider, and is applied with applicable custom rules in order to calculate a consolidated estimate of the patient financial responsibility for the medical services or procedures.

6) The system as claimed in claim 1, where in the final billing claim code is associated with a list price and a contractual amount as determined by a payer or insurance, facility, type of provider, and category of billing code.

7) The system as claimed in claim 1, wherein an estimate of the patient's financial responsibility amount is automatically calculated based on the final estimate of the billing codes and patient's medical insurance coverage, provided by the legal healthcare organization.

8) The system as claimed in claim 1, wherein the patient's healthcare information, healthcare benefits information, medical diagnosis, anatomical locations, type of encounter, are automatically shared with the legal healthcare organization and other medical service providers; and a consolidated estimate of the patient's financial responsibility is calculated and provided to the patient for all legal healthcare organizations and medical services providers networked with the system, when the final billing claim estimate is saved.

9) The system as claimed in claim 1, wherein the system may recommend one or more medical services providers, and the system automatically utilizes healthcare information, healthcare benefits information, medical diagnosis, anatomical location, and order billing codes to another medical service providers or legal healthcare organization and calculates a total cost of the medical services or procedure and an estimate of the patient financial responsibility for each of the medical services providers.

10) The system as claimed in claim 1, wherein the patient may request from one or more desired medical services providers or legal healthcare organizations to provide an estimate of billing codes and financial responsibility by selecting them, and the processing module further:
automatically shares the patient's payer information, type of visit and problems or diagnosis with the medical services providers or healthcare organizations, and requests payer benefits information, creating an estimate of billing codes and patient responsibility for that selected facility;
provides the medical services providers or legal healthcare organizations to review the estimate; and
sends the estimate to the patient, where the patient can accept one of the estimates and request the appointment.

11) The system as claimed in claim 1, wherein a consolidated estimated patient financial responsibility from multiple medical services providers or legal healthcare organizations is automatically generated for the patient.

12) The system as claimed in claim 1, wherein the system also searches in a list of billing codes for one or group of medical problems/diagnosis and historical data maintained by at least one medical specialty of the medical services provider for estimating the final billing codes, when the billing codes are not found with the medical services provider.

13) The system as claimed in claim 1, wherein the estimated medical billing codes derived for every diagnosis or group of diagnosis for each medical services provider is compared to the estimated medical billing codes derived for every diagnosis or group of diagnosis for the average medical services provider medical specialty and activates an alert on any differences in the billing codes.

14) The system as claimed in claim 2, wherein the custom rules database includes rules deciding the final billing codes to the patients depending on the parameters, such as but not limited to patient demographics, for example age, gender, predisposition to diseases, and the like, patient medical insurance eligibility, such as copay, coinsurance, deductibles and the like, existing medical insurance cover, appointment type, historical diagnosis and clinical procedures information, legal healthcare organization, medical services provider, discount after a first appointment or a first medical service, and the like.

15) The system as claimed in claim 2 wherein the custom rules can be added by the legal health care organization or the medical services provider to refine the proper billing code selection.

16) The system as claimed in claim 1, wherein the system further maintains a patient database for storing patients' detailed information; a medical services provider database for storing the detailed information and historical data of medical concepts and billing codes; and a legal healthcare database for storing detailed information and medical insurance coverage plans and the like.

17) The system as claimed in claim 1, wherein the medical services may include medical procedure, consultation, diagnosis, treatment, surgery, medication, medical devices purchased by the patient and the like.

18) The system as claimed in claim 1, wherein the medical services provider and the legal healthcare organizations may be offering both types of services including medical services and insurance coverage.

19) A method for estimating final billing codes and financial responsibility to be incurred by a patient for utilizing at least one medical service offered by at least one medical services provider or healthcare organization, the method comprising:
entering a medical query by the patient, filling in query categories representing required medical services by the patient;
generating one or more valid billing codes that are to be charged to the patient corresponding to the one or group of medical problems/medical services depending on new or existing patient and medical appointment type;
searching a historical data of billing codes of the medical services provider and place of service for identifying most frequently occurring historical billing codes;
verifying whether the valid billing codes are present in the list of most frequently occurring historical billing codes of the medical services provider;
extracting one or more billing codes, chargeable to the patient corresponding to the one or group of medical problems/medical services, from the medical concepts and billing codes database maintained by the at least one medical services provider;
mapping the valid billing codes that are present in the most frequently occurring historical billing codes, with the chargeable billing codes applicable to the patient for one or group of medical problems/services at a specified place of service;
selecting the mapped chargeable billing codes with the highest number of occurrences for the one or group of medical problems/services, while removing all other valid billing codes to obtain the final billing codes for the patient; and
wherein the historical data includes previous billing codes and medical diagnosis and procedures generated by the medical services provider for one or more medical services.

20) The method as claimed in claim 19, wherein the method further comprises: verifying whether the valid billing codes have more than one corresponding anatomical location, when valid billing codes are not present in the list of most frequently occurring historical billing codes; duplicating the billing codes for same medical diagnosis for each anatomical area; and removing other billing codes that should not be duplicated.

21) The method as claimed in claim 19, wherein the method further comprises querying the final billing code against a contract price list of patient's legal healthcare organization, and/or medical services provider, and applying applicable custom rules to the final billing codes in order to calculate a consolidated estimate of the patient financial responsibility for the medical services or procedures.

22) The method as claimed in claim 19, wherein the method further comprises recommending one or more medical services providers; automatically sending legal healthcare information, legal healthcare benefits information, medical diagnosis, anatomical location and order billing codes to another medical services providers or legal healthcare organization; and calculating a total cost of the medical services or procedure and an estimate for the patient responsibility for each of the medical services providers.

23) The method as claimed in claim 19, wherein the method further comprises searching in a list of billing codes for one or group of medical concepts/diagnosis and historical data maintained by at least one medical specialty of the medical services provider for estimating the final billing codes, when the billing codes are not found with the medical services provider.

24) The method as claimed in claim 19, wherein the estimated medical billing codes derived for every diagnosis or group of diagnosis for each medical services provider is compared to the estimated medical billing codes derived for every diagnosis or group of diagnosis for the average medical services provider medical specialty and activated an alert on any differences in the billing codes.

25) The method as claimed in claim 19, wherein the method further comprises applying a set of custom rules on the mapped chargeable billing codes along with the patient's demographics entered in a medical insurance plan to determine the financial responsibility of the patient.

26) The method as claimed in claim 25, wherein the custom rules decide the final billing codes and financial responsibility to the patients depending on the parameters, such as but not limited to patient demographics, for example age, gender, predisposition to diseases, and the like, patient medical insurance eligibility, such as copay, coinsurance, deductibles and the like, existing medical insurance cover, appointment type, historical diagnosis and clinical procedures information, legal health care organization, medical services provider, discount after a first appointment or a first medical service, and the like.

27) The method as claimed in claim 25, wherein the custom rules can be added by the legal health care organization or the medical services provider to refine the proper billing code selection.

28) The method as claimed in claim 18, wherein the medical services may include consultation, diagnosis, treatment, surgery, medication, medical device purchased by the patient and the like.

29) The method as claimed in claim 19, wherein the method further comprises:
requesting an estimate of billing codes and patient responsibility from one or more desired medical services providers or healthcare organizations to provide by a patient;
automatically sharing the patient's payer information, type of visit and problems or diagnosis, and requesting payer benefits information, for creating an estimate of billing codes and patient responsibility for that selected medical facility;
providing the medical services providers or legal healthcare organizations to review the estimate; and
sending the estimate to the patient, where the patient can accept one of the estimates and request the appointment.

30) A system for estimating final billing codes and financial responsibility to be incurred by a patient for utilizing at least one medical service offered by at least one medical services provider's medical specialty or organization, the system comprising:
a medical concepts and billing codes database storing a list of medical concepts representing a plurality of medical problems/services for the at least one medical services provider's medical specialty and corresponding billing codes yielding default costs chargeable for availing the medical services; and
a processing module to estimate the final billing code, yielding cost of services offered to the patient for the one or group of medical problems/services, by:
generating one or more valid billing codes that are to be charged to the patient corresponding to the one or group of medical problems/medical services depending on new or existing patient and medical appointment type;
searching a historical data of billing codes of the medical services provider's medical specialty and place of service for identifying most frequently occurring historical billing codes;
verifying whether the valid billing codes are present in the list of most frequently occurring historical billing codes of the medical services provider's medical specialty;
extracting one or more billing codes, chargeable to the patient corresponding to the one or group of medical problems/medical services, from the medical concepts and billing codes database maintained by the at least one medical services provider's medical specialty;
mapping the valid billing codes that are present in the most frequently occurring historical billing codes, with the chargeable billing codes applicable to the patient for one or group of medical problems/services and place of service;
selecting the mapped chargeable billing codes with the highest number of occurrences for the one or group of medical problems/services, while removing all other valid billing codes to obtain the final billing codes for the patient; and
wherein the historical data includes previous billing codes and medical diagnosis and procedures generated by the medical services provider's medical specialty for one or more medical problems/services.

31) The system as claimed in claim 30 alerts and notifies the patient and/or medical services provider's medical specialty that the billing codes need to be added, when no billing codes are found for a selected medical diagnosis.

32) A method for estimating final billing codes and financial responsibility to be incurred by a patient for utilizing at least one medical service offered by at least one medical services provider medical specialty, the method comprising:
entering a medical query by the patient, filling in query categories representing required medical services by the patient;
generating one or more valid billing codes that are to be charged to the patient corresponding to the one or group of medical problems/medical services depending on new or existing patient and medical appointment type;
searching a historical data of billing codes of the medical services provider's medical specialty for identifying most frequently occurring historical billing codes;
verifying whether the valid billing codes are present in the list of most frequently occurring historical billing codes of the medical services provider's medical specialty;
extracting one or more billing codes, chargeable to the patient corresponding to the one or group of medical problems/medical services, from the medical concepts and billing codes database maintained by the at least one medical services provider's medical specialty;
mapping the valid billing codes that are present in the most frequently occurring historical billing codes, with the chargeable billing codes applicable to the patient for one or group of medical problems/services;
selecting the mapped chargeable billing codes with the highest number of occurrences for the one or group of medical problems/services, while removing all other valid billing codes to obtain the final billing codes for the patient; and
wherein the historical data includes previous billing codes and medical diagnosis and procedures generated by the medical services provider's medical specialty for one or more medical services.

33) The method as claimed in claim 32 further comprises alerting and notifying the patient and/or medical services provider's medical specialty that the billing codes need to be added, when no billing codes are found for a selected medical diagnosis.
